(19) United States
(12) Patent Application Publication
(10) Pub. No.: US 2009/0113058 A1
(43) Pub. Date: Apr. 30, 2009

(54) Terminal server draining

(75) Inventors: Jiazhi Ou, Bellevue, WA (US); Sriram Sampath, Redmond, WA (US); David T. Dopson, Seattle, WA (US); Rouslan Beletski, Kenmore, WA (US); Huei Chung Wang, Kirkland, WA (US)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 11/926,489

(22) Filed: Oct. 29, 2007

(51) Int. Cl. G06F 15/16

(52) U.S. Cl. 709/227

(57) ABSTRACT

Techniques are described for managing and controlling connections of server sessions, including systems and methods for managing and controlling connections to a server computer. Connections are monitored to a server computer depending on a “drain state” of the server computer. If the server is in drain mode, requests to initiate a fresh session with the server computer are rejected, or deferred until the server computer comes out of the drain state.

### BACKGROUND

A number of techniques exist that allow server computers to host one or more applications. The applications can be accessed by a plurality of client devices over a network, such as Internet, a LAN, and so on. An example of such a technique is Terminal Services™ (TS) developed by the Microsoft® Corporation. In these techniques, users can access the applications remotely by establishing a connection allowing communication between a server computer hosting applications and a remote client device. This creates a session between the server computer and the user. During the session, users can interact and use applications hosted on the server computer, as if the applications were present locally on the remote client device.

In certain cases, maintenance issues may require restarting or shutting down the server computer by an individual, such as a system administrator. During restart or shut down, all sessions terminate. Such termination may lead to loss of data. Furthermore, the system administrator may disallow further connections, thereby making it difficult for a user to log on and save their work at a current session. Additionally, in such cases the system administrator may also be unable to remotely access the server computer to resolve one or more related issues.

Generally, a session creates an environment in which the server computer and the client device can communicate with each other within an active session. The sessions can be associated with two primary states, namely an active session and a disconnected session. The active session can allow a user to interact with applications hosted on a server computer through a client device. The disconnected sessions exist when the interaction between the user and the applications cease. In such a case, the applications continue to execute at the server computer end. In some cases, due to unforeseen circumstances, server computer maintenance may require the system administrator to restart or shutdown the server computer. In such cases, the system administrator can configure the server computer to disable all active connections. Such an improper or forced termination may disrupt sessions that may be running on the server computer and resulting in loss of data associated with a user, previously connected to a session. Typically, in such remote application based systems, the data is stored at the server computer, which may result in data loss if the session terminates. Therefore, a need exists that would allow individuals to connect to sessions that may have been disconnected (e.g., disconnection because the user leaves from work).

### SUMMARY

This summary is provided to introduce concepts for managing and controlling connections to existing server computer sessions. These concepts are further described below in the detailed description. This summary is not intended to identify essential features of the claimed subject matter, nor is it intended for use in determining the scope of the claimed subject matter.

In an embodiment, connection of a user and the remote client device associated with the user is managed and controlled by determining previously existing sessions, and drain state a system that includes one or more server computers that the client device can be connected to.

### BRIEF DESCRIPTION OF THE DRAWINGS

The detailed description is described with reference to the accompanying figures. In the figures, the left most digit(s) of a reference number identifies the figure in which the reference number first appears. The same numbers are used throughout the drawings to reference like features and components.

FIG. 1 is a block diagram illustrating an exemplary network for managing and controlling connections to server computers.

FIG. 2 is a block diagram illustration of an exemplary server device.

FIG. 3 is a flowchart illustrating an exemplary process for managing and controlling connections to a standalone server computer device.

FIG. 4 is a flowchart illustrating an exemplary process for managing and controlling connections to a server computer collection.

FIG. 5 is a block diagram an exemplary general computer environment.

### DETAILED DESCRIPTION

Described are systems and methods for managing and controlling connections of server sessions, including systems and methods for managing and controlling connections to a server computer session. To implement such systems and methods, according to an embodiment, an agent or module within the server computer controls and monitors connections to the server computer depending on a “drain state” of the server computer. For the purposes of this description, the drain state of a system (e.g., a server computer) can be understood to include a system state that disallows any fresh connections to server computer sessions. Therefore, requests to initiate a fresh session with the server computer are rejected, or deferred until the server computer comes out of the drain state.

The agent can determine whether a system, such as the server computer, is in the drain state by monitoring server related information. Once the agent determines the server computer is in the drain state, the agent can identify whether the request for connection is from a user who was previously disconnected from a session. On affirming that the user was previously connected to a server computer session, the agent allows the client device of the user to reconnect to the disconnected session. This allows the user to save the user's data, after which the user can safely log-off from the session. In case no such indications of previously existing sessions with the server computer are found to exist, the agent disallows any session connection requests by other users until the drain state persists.

In an implementation, the server computer can be implemented as a server collection. The server collection may include a plurality of server computer devices that may be operating conjunctively to implement the functionality of a server computer device. The server collection can be implemented such that some of the applications may be distributed across constituent server computer devices. The server collection may also be referred to as a “server farm.” Communication requests for accessing one or more applications can be directed to one or more of the server computer devices included within the server farm, on which the application may be installed. When the request is directed to one of the server computer devices in the drain state, the agent can redirect the connection request to another server computer device, not in the drain state in the server farm.

While aspects of described systems and methods for managing and controlling connection to a server computer session can be implemented in any number of different computing systems, environments, and/or configurations, embodiments of system analysis and management are described in the context of the following system architecture(s).

### An Exemplary System

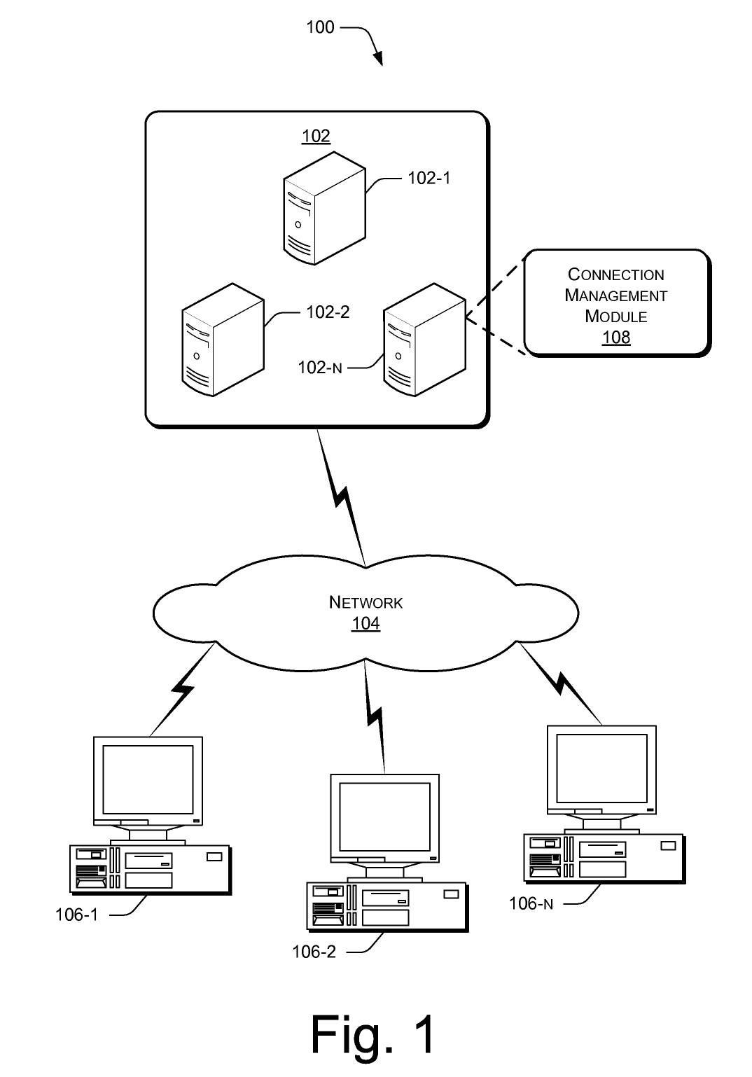

FIG. 1 shows an exemplary remote server access system 100 for managing and controlling connections to a previously existing server computer session in a client-server computing environment. The system 100 includes one or more server computer devices 102-1, 102-2, . . . , 102-N, a network 104 and one or more client devices 106-1, 106-2, . . . , 106-N. For the purposes of the present description, server computer devices 102-1, 102-2, . . . , 102-N can interchangeably be referred to as server 102. The server 102 may exist either as a server collection including a plurality of server computer devices 102-1, 102-2, . . . , 102-N or may be a standalone device.

The system 100 can include any number of client devices 106-1, 106-2, . . . 106-N, interchangeably referred to as clients 106. For example, the system 100 can be a company network, including thousands of office PCs, various server computers, and other computing-based devices spread throughout several countries. Alternately, in another implementation, the system 100 can include a home network with a limited number of PCs. The clients 106 can be coupled to each other in various combinations through a wired and/or wireless network, including a LAN, WAN, or any other networking technology known in the art.

Server 102 can communicate with the clients 106 through a network 104. The system 100 may be a Terminal Server™ system, in which one or more clients rely on applications that are executed on a server computer (e.g., server 102). The server 102 and the clients 106 can communicate with each other based on one or more protocols, such as remote desktop protocol (RDP). The use of such communication protocols, such as RDP, may be implemented in the context of a remote client access system such as a Terminal Services™ system.

The network 104 may be a wireless or a wired network, or a combination thereof. The network 104 may also be a collection of individual networks, interconnected with each other and functioning as a single large network (e.g., the Internet or an intranet). Examples of such individual networks include, but are not limited to Local Area Networks (LANs), Wide Area Networks (WANs), and Metropolitan Area Networks (MANs). Further, the individual networks may be wireless or wired networks, or a combination thereof. Furthermore, the network 104 connecting the server 102 and clients 106 may implement a transport protocol such as transmission control protocol over Internet protocol (TCP/IP).

The server 102 may host a number of applications that may be accessed or executed by the one or more of the clients 106. Typically, the clients 106 may establish a connection with the server 102 prior to accessing the applications. The server 102 may create a connection based on the credentials of the users, such as clients 106, requesting access to the one or more applications on the server 102. The session can be established on validation of the users based on their credentials. Once the session has been established between the server 102 and the clients 106, the clients 106 can access and utilize the applications hosted on the server 102. Once the clients 106 are finished using the applications, they may terminate their session with the server 102 by logging off.

In certain cases, activities like server computer maintenance may require an individual (e.g., the system administrator), to forcefully terminate one or more existing sessions that may be active on the server 102. Typically, users (through clients 106) may try to reconnect to their terminated sessions to save their work; however, as an example, the system administrator, because of maintenance, may disallow further attempts to reconnect users to their sessions. This may result in loss of data. In such cases, the session applications may continue to execute on the server 102. For example, such applications and their execution may be terminated after a certain period at the server 102.

To implement managing and controlling connections to a server computer, the server 102 includes a connection management module 108. The connection management module 108 manages and controls the connection of the clients 106 to the server 102. The controlling and managing of the connections to one or more server computer sessions is based on a drain state of a system, such as the server 102. As indicated previously, the drain state of a system can include a system state that disallows any fresh connections to the server computer sessions. Therefore, when the server 102 is in the drain state, connection requests for new sessions would be disallowed, after a forceful termination. The requests for new sessions would continue to be disallowed till the drain state for the server 102 persists.

In one implementation, the server 102 can include two or more server computer devices 102-1, 102-2, . . . , 102-N. In such cases, one or more modules can be instrumented to redirect connection requests to one of the server computer devices 102-1, 102-2, . . . , 102-N that is not in the drain state. For example, in case server computer device 102-1 is in the drain state, then all connection requests directed to it can be routed to one or more of the server computer devices 102-2, 102-3, . . . , 102-N which are not in the drain state.

The connection management module 108 monitors information associated with the server 102 for which the drain state may be defined. Based on the information associated with the server 102, the connection management module 108 determines whether the clients 106 had a previously existing session before the system administrator forcefully terminated the session associated with the server 102.

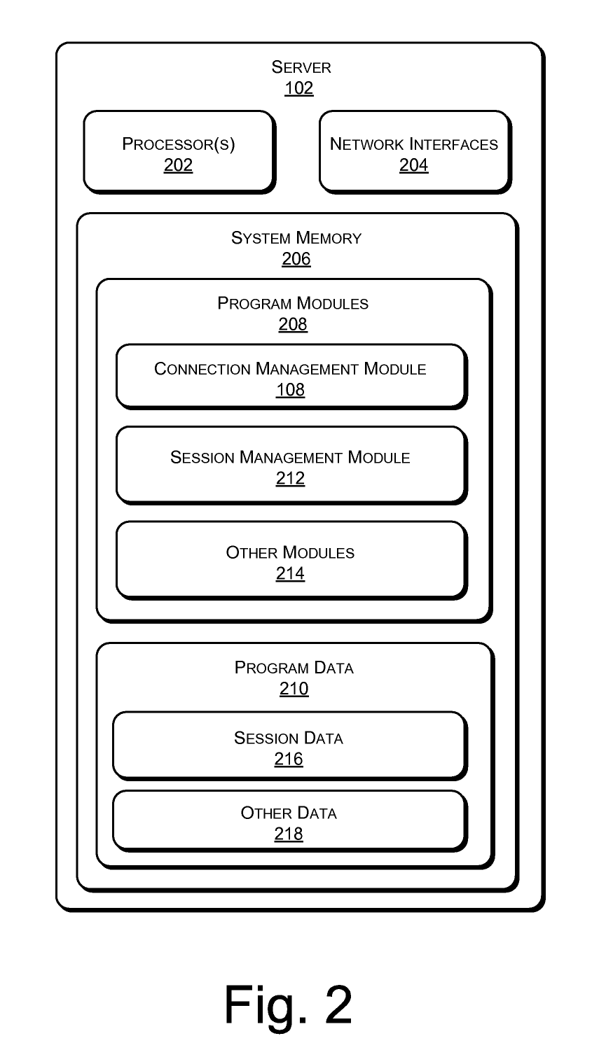

Upon determining whether the server 102, is in the drain state, the connection management module 108 allows connection requests to the server 102 for clients 106 that had a previously existing connection. Once the clients 106 are reconnected to the server 102, the clients 106 are able to save the work in the existing session and minimize possible data loss. Alternatively, if one or more new clients 106 attempt to connect to the server 102 while the server 102 persists in the drain state, the connection management module 108 disallows the connection requests for a new session. The working of the connection management module 108 and other components of the server 102 for controlling and managing connection to the server 102 is discussed in further detail in description of FIG. 2.

### An Exemplary Server Computer

FIG. 2 illustrates an exemplary server 102 for controlling and managing connections of the clients 106 with it. The server 102 may be implemented as one of a number of nodes in a website, an organizational intranet, or other network such as a local area network or as a separate computer not included as one of the nodes. The server 102 includes one or more processor(s) 202, network interfaces 204, and a system memory 206. The processor(s) 202 may be implemented as one or more microprocessors, microcomputers, microcontrollers, dual core processors, and so forth. Among other capabilities, the processor(s) 202 can be configured to fetch and execute computer readable instructions stored in the memory 206.

The network interfaces 204 enable the server 102 to communicate to other computing-based devices, such as clients 106, over the network 104. Furthermore, the network interface(s) 204 may include one or more ports for connecting a number of computing devices to the each other or to another server computer. The network interface(s) 204 can facilitate communications within a wide variety of networks and protocol types, including wired networks (e.g. LAN, cable, etc.) and wireless networks (e.g. WLAN, cellular, satellite, etc.).

The system memory 206 can include any computer-readable medium known in the art, for example, volatile random access memory (e.g., RAM) and non-volatile read-only memory (e.g., ROM, flash memory, etc.). As illustrated in FIG. 2, the memory 108 also can include program modules 208 and data 210. The program modules 208 generally include routines, programs, objects, components, data structures, etc., that perform particular tasks or implement particular abstract data types. In an implementation, the program modules 208 include the connection management module 108, a session management module 212, and other modules 214. The other modules 214 may include programs that supplement applications on a computing-based device, such as an operating system.

As discussed above, the connection management module 108 manages and controls the connection of clients 106 to the server 102. The system administrator depending on the maintenance to be performed, may define a drain state for the server 102. The system administrator then may instrument the settings of the server 102 to disallow connection requests, based on information associated with server 102. The information associated with the server 102 is indicative of previous sessions that may be present between one or more of the clients 106 and the server 102. The connection management module 108 ascertains the drain state of the server 102 by scanning one or more information associated with the server 102. For example, the connection management module 108 may scan the registry settings of the server 102 to determine if the drain state has been defined or not defined. In an implementation, the registry settings may be related to the following registry key:

HKEY_LOCAL_MACHINE\SYSTEM\CURRENTSET\CONTROL\
TerminalServer\TS SERVER\DRAINMODE

The connection management module 108, on determining that the drain state of the server 102 to be present, monitors the incoming requests for new connection that may be made by one or more of the clients 106. In an implementation, connection management module 108 may be implemented as a thread or a program. Example of such programs can include remote connection manager (or RCM) implemented within the Terminal Services environment. In an implementation, the connection management module 108 can be instrumented to perform a validation process for allowing connection requests by one or more of the clients 106. The validation process can be performed based on the user credentials of the clients 106.

Once the credentials of the clients 106 are validated, the session management module 212 compares the credential details of the clients 106 with the credential details associated with previous sessions. In an implementation, the credential details of the previous sessions can be stored as session data 216. The session management module 212 compares the user credentials of the new requests and compares the user credentials with session data 216. The session management module 212 allows the connection to a previously existing session for all users having credentials similar to the session data 216. Once the connection and a session are established, the respective clients 106 can save their work and close their sessions in a proper manner. In an implementation, once a connection is established, the session management module 212 can generate a message for the appropriate clients 106 to instruct such appropriate clients 106 to log-off in a proper manner once reconnected. In cases when the session management module 212 finds the user credentials of the clients 106 dissimilar from the session data 216, the session management module 212 disallows any fresh connections to the server 102. The session management module 212 can then manage all active connections and all connections that may have been deactivated due to the system administrator forcefully terminating ongoing sessions at the server computer for maintenance. In an implementation, the session management module 212 can be implemented as a local session manager or LSM for managing the active and the inactive or disconnected sessions.

The above example is discussed in context of clients 106 requesting for a session. In certain cases, the system administrator may wish to access the applications or some other programs hosted on the server 102. In an implementation, the connection management module 108 may support creation of a new session for the system administrator, or a user with certain specific credentials and rights.

As discussed above server 102, which includes one or more server computers 102-1, 102-2, . . . , 102-N, may be referred to as a server farm. As a server farm, the applications may be accessed by one or more of the clients 106 and can be distributed across the server computer devices in the server farm. Each of the server computer devices within the server farm can be implemented as broadly described above in reference to FIGS. 1 and 2.

In an implementation, one or more of the server computer devices, such as server computer devices 102-1, 102-2, . . . , 102-N within the server 102 (i.e., server farm) can include the connection management module 108, session management module 212 and other modules 214. The connection management module 108, as discussed above, manages and controls the requests for connection to the servers based on the drain state of such as the server computer devices within the server 102 (i.e., server farm).

To this end, the connection management module 108 within one of the server computer devices, for example server 102-N, scans the server 102 (i.e., server farm) for any disconnected sessions. The disconnected sessions may be associated with the one or more clients 106. The sessions may have been disconnected due to a forceful termination by the system administrator, for reasons such as implementing any changes on the system, including updating, maintenance, and so on. The connection management module 108 can then determine if a specific client, for example client 106-1, has disconnected sessions on the server 102 (i.e., server farm). If the connection management module 108 ascertains the absence of any disconnected session, the connection management module 108 can perform load balancing by routing the connection request from the client 106-1 to the appropriate server computer device, such as server 102-N.

If the connection management module 108 detects any disconnected sessions for the user, such as client 106-1, the connection management module 108 instructs the session management module 212 to fetch the information associated with a target server computer to which the request may be routed. On receiving the appropriate information associated with the target server computer, the connection management module 108 redirects the request to the respective server computer device. If there are no existing disconnected sessions, the connection management module 108 then determines the drain state of a source server computer. If the source server computer is found to be in a drain state, the connection management module 108 disallows creation of new session on the source server computer. In such a case, the entire process may be implemented again to redirect the request to a server computer device, such as server computer devices 102-2 that is not in the drain state in the server farm. In case the source server computer is not in the drain state, the connection management module 108 allows connection to the server computer, such as server 102-N, creating a session between the client 106-1 and the server 102-N.

### Exemplary Methods

Exemplary methods for managing and controlling connections to server computer devices are described with reference to FIGS. 1 and 2. These methods may be described in the general context of computer executable instructions. Generally, computer executable instructions can include routines, programs, objects, components, data structures, procedures, modules, functions, and the like that perform particular functions or implement particular abstract data types. The methods may also be practiced in a distributed computing environment where functions are performed by remote processing devices that are linked through a communications network. In a distributed computing environment, computer executable instructions may be located in both local and remote computer storage media, including memory storage devices.

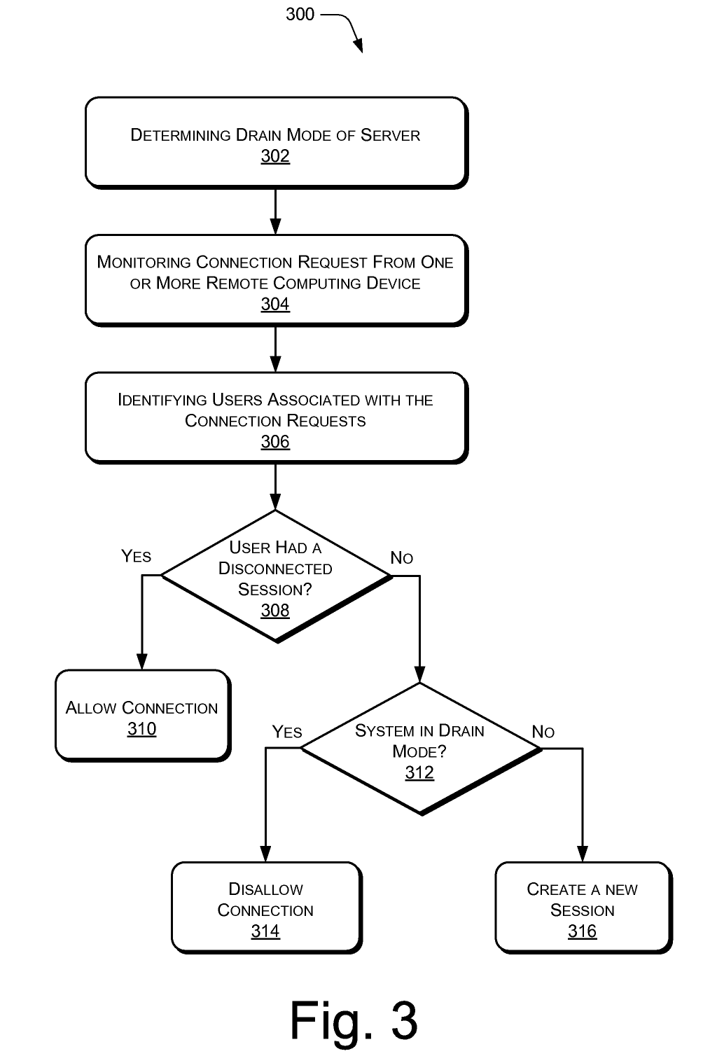

FIG. 3 illustrates an exemplary method 300 for managing and controlling connections to a standalone server computer device. The method 300 is illustrated as a collection of blocks in a logical flow diagram, which represents a sequence of operations that can be implemented in hardware, software, or a combination thereof. In the context of software, the blocks represent computer instructions that, when executed by one or more processors, perform the recited operations. The order in which the method is described is not intended to be construed as a limitation, and any number of the described blocks can be combined in any order to implement the process, or an alternate process. Additionally, individual blocks may be deleted from the method without departing from the spirit and scope of the subject matter described herein. For discussion purposes, the method 300 is described with reference to the implementations of FIGS. 1-2.

At block 302, the drain state associated with a system is determined. For example, the connection management module 108 determines the drain state of the server 102. In an implementation, the connection management module 108 determines the drain state by monitoring state related information of the server 102. In another implementation, the connection management module 108 determines the drain state by monitoring registry settings associated with the server 102.

At block 304, connection requests from one or more users are monitored. For example, the connection management module 108 upon determining the drain state of the server 102 to be active, monitors the incoming requests for new connections that may be made by one or more of the clients 106. In an implementation, connection management module 108 may be implemented as the remote connection manager or RCM within the Terminal Server™ based systems. In an implementation, the connection requests by one or more of the clients 106 can be validated by the connection management module 108 based on the user credentials of the clients 106.

At block 306, users associated with the connection requests are identified. For example, the session management module 212 identifies users associated with the connection requests based on the credentials of the users.

At block 308, a determination is made to ascertain whether the user had a previously existing session. For example, the session management module 212 compares the credential details of the clients 106 with the credential details associated with previous sessions. In an implementation, the credential details of the previous sessions can be stored as session data 216. The session management module 212 compares the user credentials of the new requests and compares it with session data 216. User credentials of the clients 106 similar to the session data 216 can be indicative of previously existing sessions with the server 102.

Based on the determination whether the user had a previously existing session, and whether the system is in drain mode, a new session may be allowed or disallowed. For example, if it is determined that one of the clients 106 had a disconnected session (i.e., following the “YES” path from block 308), at block 310 the connection management module 108 allows the connection to be established based on the request of the respective one of the clients 106.

If it is determined that one of the clients 106 requesting for a new session did not have a previous existing session (i.e., following the “NO” path from block 308), a further determination can be made to ascertain whether the system under consideration is in the drain state or not. For example, at block 312, the drain state associated with the server 102 can be determined. In one implementation, the connection management module 108 can ascertain whether the server 102 is in the drain state or not. If the connection management module 108 determines the server 102 to be in the drain state (i.e., following the “YES” path from block 312), at block 314 the connection management module 108 disallows the creation of any new session. In one implementation, the connection management module 108 can also display a message indicating to the respective clients 106 to try to connect again at a later instance, allowing new connections when the server 102 no longer exists in the drain state. On the other hand if the connection management module 108 finds that the server 102 is not in the drain state (i.e., following the “NO” path from block 312), the connection management module 108 allows the connection to be established based on the request of the respective one of the clients 106.

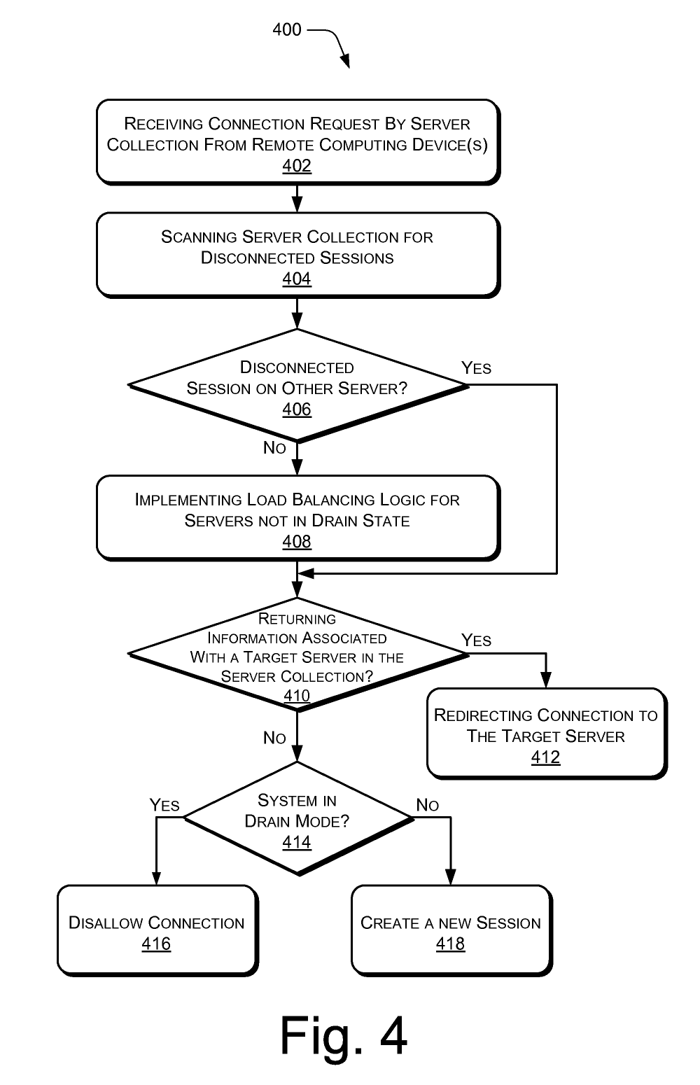

FIG. 4 illustrates an exemplary method 400 for managing and controlling connections to a server computer collection described with reference to FIGS. 1 and 2. The order in which the method is described is not intended to be construed as a limitation, and any number of the described method blocks can be combined in any order to implement the method, or an alternate method. Additionally, individual blocks may be deleted from the method without departing from the spirit and scope of the subject matter described herein. Furthermore, the method can be implemented in any suitable hardware, software, firmware, or combination thereof.

At block 402, connection requests for establishing a session are received by a server computer collection from one or more of the clients 106. The server computer collection, such as the server 102 (i.e., server farm) can include a plurality of server computers 102-1, 102-2, . . . , 102-N. Each of the server computer devices within the server 102 (i.e., server farm) can be implemented as broadly described above in reference to FIGS. 1 and 2. The server 102 (i.e., server farm) receives connection requests from one or more of the clients 106. In one implementation, the connection management module 108 within one of the server computer devices, such as server 102-N, receives the connection requests.

At block 404, the server computer collection is scanned to detect one or more disconnected sessions. For example, the connection management module 108 within one of the server computer devices such as, server 102-N, scans the server 102 (i.e., server farm) for any disconnected sessions. The disconnected sessions may be such that may be associated with the one or more clients 106.

At block 406, a determination is made to ascertain whether a user has disconnected sessions on other server computers. For example, the connection management module 108 can then determine if a specific client, such as client 106-1, has disconnected sessions on the server 102 (i.e., server farm). If the connection management module 108 determines the absence of any disconnected sessions, (i.e., following the “NO” path from block 406) the operation proceeds to block 408. If the connection management module 108 determines the existence of disconnected sessions, the process proceeds to block 410.

At block 408, load balancing logic can be implemented. For example, the connection management module 108 can implement a load balancing logic. In one implementation, the connection management module 108 can implement load balancing logic based on the drain state of one of the server computing devices in the server 102 (i.e., server farm). Based on the load balancing, if it is determined that the connection request from the client 106-1 should be routed to the appropriate server computer device, such as server 102-N, the connection management module 108 fetches the information associated with a target server computer to which the request may be routed. In an implementation, load balancing can be performed by the Session Broker Server or SB Server present within systems implementing Terminal Server™ systems.

At block 410, a determination is made to ascertain whether the information associated with the target server computer is returned or not. For example, the connection management module 108 can determine if the information associated with the target computer server, such as server 102-N, is returned or not. Upon receiving the appropriate information associated with the target server computer (i.e., following the “YES” path from block 410), the connection management module 108 redirects the request to the respective server computer device, such as server 102-N (block 412).

However, if no information associated with the target server computer is returned (i.e., following the “NO” path from block 410), a determination can be made to ascertain whether the server computer devices included in server 102 (i.e., server farm) to which the request was directed is in the drain state or not (block 414). For example, the session management module 212 determines the drain state of target server computer. If the source server computer is found to be in a drain state (i.e., following the “YES” path from block 414), the connection management module 108 disallows all connection requests to the source server computer, as indicated at block 416 In case the source server computer is not in the drain state (i.e., following the “NO” path from block 414), the connection management module 108 allows connection to the server computer, such as server 102-1, creating a new session between the client 106-1 and the server 102-1, as indicated by block 418.

### An Exemplary Computing Environment

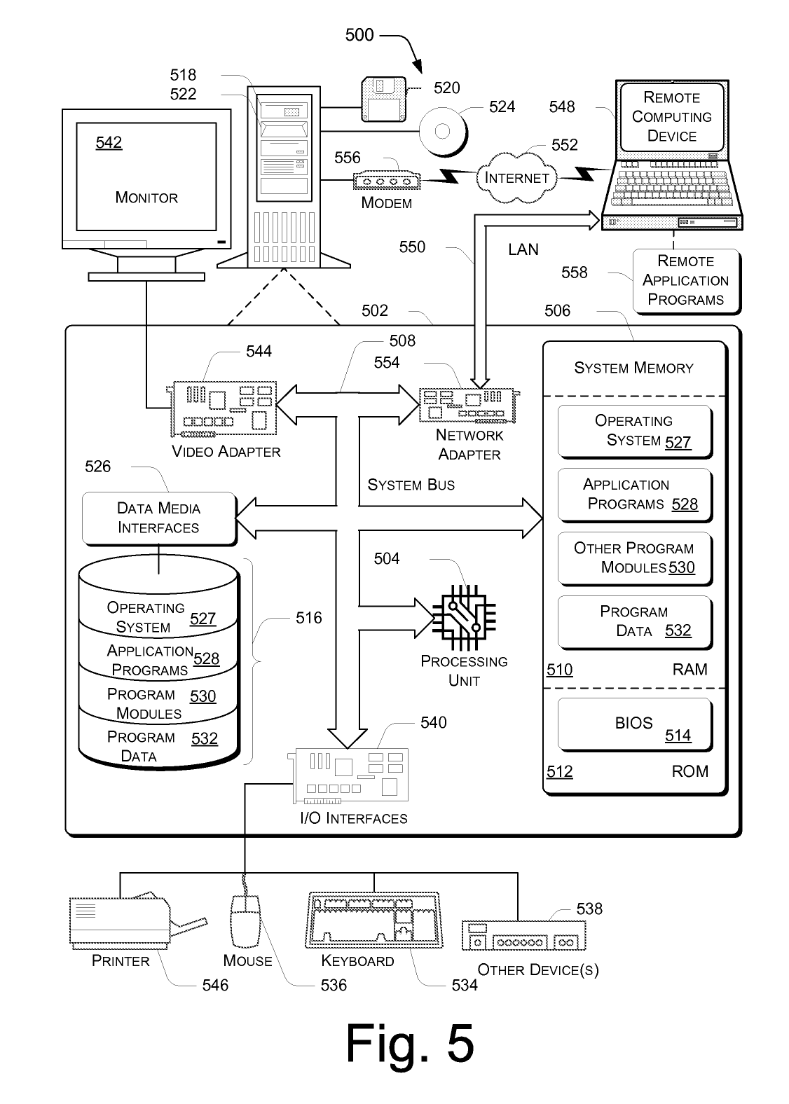

FIG. 5 illustrates an exemplary general computer environment 500, which can be used to implement the techniques described herein, and which may be representative, in whole or in part, of elements described herein. The computer environment 500 is only one example of a computing environment and is not intended to suggest any limitation as to the scope of use or functionality of the computer and network architectures. Neither should the computer environment 500 be interpreted as having any dependency or requirement relating to any one or combination of components illustrated in the example computer environment 500.

Computer environment 500 includes a general-purpose computing-based device in the form of a computer 502. Computer 502 can be, for example, a desktop computer, a handheld computer, a notebook or laptop computer, a server computer, a game console, and so on. The components of computer 502 can include, but are not limited to, one or more processors or processing units 504, a system memory 506, and a system bus 508 that couples various system components including the processor 504 to the system memory 506.

The system bus 508 represents one or more of any of several types of bus structures, including a memory bus or memory controller, a peripheral bus, an accelerated graphics port, and a processor or local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

Computer 502 typically includes a variety of computer readable media. Such media can be any available media that is accessible by computer 502 and includes both volatile and non-volatile media, removable and non-removable media.

The system memory 506 includes computer readable media in the form of volatile memory, such as random access memory (RAM) 510, and/or non-volatile memory, such as read only memory (ROM) 512. A basic input/output system (BIOS) 514, containing the basic routines that help to transfer information between elements within computer 502, such as during start-up, is stored in ROM 512 is illustrated. RAM 510 typically contains data and/or program modules that are immediately accessible to and/or presently operated on by the processing unit 504.

Computer 502 may also include other removable/non-removable, volatile/non-volatile computer storage media. By way of example, FIG. 5 illustrates a hard disk drive 516 for reading from and writing to a non-removable, non-volatile magnetic media (not shown). furthermore FIG. 5 illustrates a magnetic disk drive 518 for reading from and writing to a removable, non-volatile magnetic disk 520 (e.g., a “floppy disk”), additionally FIG. 5 illustrates an optical disk drive 522 for reading from and/or writing to a removable, non-volatile optical disk 524 such as a CD-ROM, DVD-ROM, or other optical media. The hard disk drive 516, magnetic disk drive 518, and optical disk drive 522 are each connected to the system bus 508 by one or more data media interfaces 526. Alternately, the hard disk drive 516, magnetic disk drive 518, and optical disk drive 522 can be connected to the system bus 508 by one or more interfaces (not shown).

The disk drives and their associated computer-readable media provide non-volatile storage of computer readable instructions, data structures, program modules, and other data for computer 502. Although the example illustrates a hard disk 516, a removable magnetic disk 520, and a removable optical disk 524, it is to be appreciated that other types of computer readable media which can store data that is accessible by a computer, such as magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like, can also be utilized to implement the exemplary computing system and environment.

Any number of program modules can be stored on the hard disk 516, magnetic disk 520, optical disk 524, ROM 512, and/or RAM 510, including by way of example, an operating system 526, one or more application programs 528, other program modules 530, and program data 532. Each of such operating system 526, one or more application programs 528, other program modules 530, and program data 532 (or some combination thereof) may implement all or part of the resident components that support the distributed file system.

A user can enter commands and information into computer 502 via input devices such as a keyboard 534 and a pointing device 536 (e.g., a “mouse”). Other input devices 538 (not shown specifically) may include a microphone, joystick, game pad, satellite dish, serial port, scanner, and/or the like. These and other input devices are connected to the processing unit 804 via input/output interfaces 540 that are coupled to the system bus 508, but may be connected by other interface and bus structures, such as a parallel port, game port, or a universal serial bus (USB).

A monitor 542 or other type of display device can also be connected to the system bus 508 via an interface, such as a video adapter 544. In addition to the monitor 542, other output peripheral devices can include components such as speakers (not shown) and a printer 546, which can be connected to computer 502 via the input/output interfaces 540.

Computer 502 can operate in a networked environment using logical connections to one or more remote computers, such as a remote computing-based device 548. By way of example, the remote computing-based device 548 can be a personal computer, portable computer, a server computer, a router, a network computer, a peer device or other common network node, and the like. The remote computing-based device 548 is illustrated as a portable computer that can include many or all of the elements and features described herein relative to computer 502.

Logical connections between computer 502 and the remote computer 548 are depicted as a local area network (LAN) 550 and a general wide area network (WAN) 552. Such networking environments are commonplace in offices, enterprise-wide computer networks, intranets, and the Internet.

When implemented in a LAN networking environment, the computer 502 is connected to a local network 550 via a network interface or adapter 554. When implemented in a WAN networking environment, the computer 502 typically includes a modem 556 or other means for establishing communications over the wide network 552. The modem 556, which can be internal or external to computer 502, can be connected to the system bus 508 via the input/output interfaces 540 or other appropriate mechanisms. It is to be appreciated that the illustrated network connections are exemplary and that other means of establishing communication link(s) between the computers 502 and 548 can be employed.

In a networked environment, such as that illustrated with computing environment 500, program modules depicted relative to the computer 502, or portions thereof, may be stored in a remote memory storage device. By way of example, remote application programs 558 reside on a memory device of remote computer 548. For purposes of illustration, application programs and other executable program components such as the operating system are illustrated herein as discrete blocks, although it is recognized that such programs and components reside at various times in different storage components of the computing-based device 502, and are executed by the data processor(s) of the computer.

Various modules and techniques may be described herein in the general context of computer-executable instructions, such as program modules, executed by one or more computers or other devices. Generally, program modules include routines, programs, objects, components, data structures, etc. that performs particular tasks or implement particular abstract data types. Typically, the functionality of the program modules may be combined or distributed as desired in various embodiments.

An implementation of these modules and techniques may be stored on or transmitted across some form of computer readable media. Computer readable media can be any available media that can be accessed by a computer. By way of example, and not limitation, computer readable media may comprise “computer storage media” and “communications media.”

“Computer storage media” includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

Alternately, portions of the framework may be implemented in hardware or a combination of hardware, software, and/or firmware. For example, one or more application specific integrated circuits (ASICs) or programmable logic devices (PLDs) could be designed or programmed to implement one or more portions of the framework.

### CONCLUSION

Although embodiments for managing and controlling connections to a server computer have been described in language specific to structural features and/or methods, it is to be understood that the subject of the appended claims is not necessarily limited to the specific features or methods described. Rather, the specific features and methods are disclosed as exemplary implementations for managing and controlling connections to a server computer.

What is claimed is:

1. A server computer comprising:
one or more processors;
a memory configured to the processors; and
a connection management module that manages and controls connection of remote client devices to a server computer based on a drain state of the server, and monitors information associated with the server computer for which the drain state is defined.

2. The server computer of claim 1, wherein configure UI, command line tool, and WMI can set the drain state of the server.

3. The server computer of claim 1, wherein connection management module ascertains the drain state of the server computer by scanning information associated with the server computer.

4. The server computer of claim 1, wherein connection management module ascertains the drain state of the server computer by scanning registry settings of the server computer to determine if the drain state has been defined, wherein the registry settings are related to a registry key.

5. The server computer of claim 1, wherein the connection management module performs a validation process based user credentials for allowing connection requests by one or more of the remote client devices.

6. The server computer of claim 1, wherein the connection management module creates a new session for a user with certain credentials and rights.

7. The server computer of claim 1 further comprising a session management module that compares credential details of the remote client devices with credential details associated with previous sessions.

8. The server computer of claim 7, wherein the session management module generates a message for the appropriate clients to log-off in a proper manner once reconnected.

9. The server computer of claim 1, wherein the server computer is a stand-alone server, or one of multiple server computers of a server farm.

10. The server computer of claim 9, wherein the connection management module scans other server computers of the server farm for disconnected sessions.

11. The server computer of claim 9 further comprising a session management module that is instructed by the connection management module, to fetch information associated with a target server computer to which a reconnected session request may be routed.

12. A method comprising:
determining a drain state of a system;
monitoring connection requests of one or more users of the system;
identifying users associated with the connection requests; and
allowing connection of users based on the drain state of the system and previous existing session of the user.

13. The method of claim 12, wherein the determining is performed based on registry settings of the system.

14. The method of claim 12, wherein monitoring includes validating the one or more users.

15. The method of claim 12, wherein the identifying is based on credentials of the one or more users.

16. The method of claim 12, wherein a user is not allowed to establish a new session if the server is in drain mode and the user did not have a previous existing session.

17. A method comprising:
receiving requests to establish a session from one or more client devices to one or more server computers;
scanning the one or more server computers for disconnected sessions;
determining whether any of the client devices has a disconnected session on any of the server computers;
returning information as to a target server computer associated with the disconnected session;
determining drain state of the source server computer;
returning information of a target server computer if the source server computer is in drain state;
determining drain state of the target server computer; and
redirecting connection to the target server computer if the target server computer is not in drain state.

18. The method of claim 17, wherein the receiving is performed at one of the server computers.

19. The method of claim 17, wherein load balancing is performed on the one or more server computers, if the determining shows no disconnected session.

20. The method of claim 17, wherein connection is disallowed if the determining drain shows that the one or more server computers are in drain state.

21. The method of claim 17, wherein the redirecting is performed to any server computer not in drain state.
